(19) United States
(12) Patent Application Publication
(10) Pub. No.: US 2015/0262109 A1
(43) Pub. Date: Sep. 17, 2015

(54) GAMIFICATION BASED PERFORMANCE TRACKING

(71) Applicant: Comenity LLC, Columbus, OH (US)

(72) Inventors: Richard Barber AINSWORTH, III, Dublin, OH (US); James WALZ, Blacklick, OH (US); Christian BILLMAN, Gahanna, OH (US); Uchenna CHILAKA, Ghanna, OH (US); Adam KOLTNOW, Worthington, OH (US)

(73) Assignee: COMENITY LLC, Columbus, OH (US)

(21) Appl. No.: 14/660,713

(22) Filed: Mar. 17, 2015

Related U.S. Application Data
(60) Provisional application No. 61/954,472, filed on Mar. 17, 2014.

(51) Int. Cl. G06Q 10/06

(52) U.S. Cl. CPC G06Q 10/06398

(57) ABSTRACT

A method for gamification based performance tracking is described. The method accesses a leaderboard having a set of participants. The leaderboard is updated to provide motivation to each of the participants in the set of participants. In addition, mobile device notifications are provided to one or more of the participants as the leaderboard is updated.

### CROSS-REFERENCE TO RELATED APPLICATIONS

This application claims priority to and benefit of co-pending U.S. Patent Application No. 61/954,472, filed on Mar. 17, 2014 entitled “GAMIFICATION FOR RETAIL” by Richard Barber Ainsworth, III et al., having Attorney Docket No. ADS-045.PRO, and assigned to the assignee of the present application.

### BACKGROUND

A leaderboard is a means by which users can track their performance subjective to others. Leaderboards visually display where a user stands with regard to other users. Unless a user begins a leaderboard as a participant in a small group of known participants, the user remains unaware of how his performance compares to performances of participants whom the user personally knows. The user only knows how he has performed as compared with the public at large.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram that illustrates an embodiment of a sub-leaderboard provider, in accordance with an embodiment.

FIG. 2 is a block diagram that illustrates a system that includes a sub-leaderboard, in accordance with an embodiment.

FIG. 3 depicts a flow diagram for a method for providing a sub-leaderboard, in accordance with an embodiment.

FIG. 4 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### NOTATION AND NOMENCLATURE

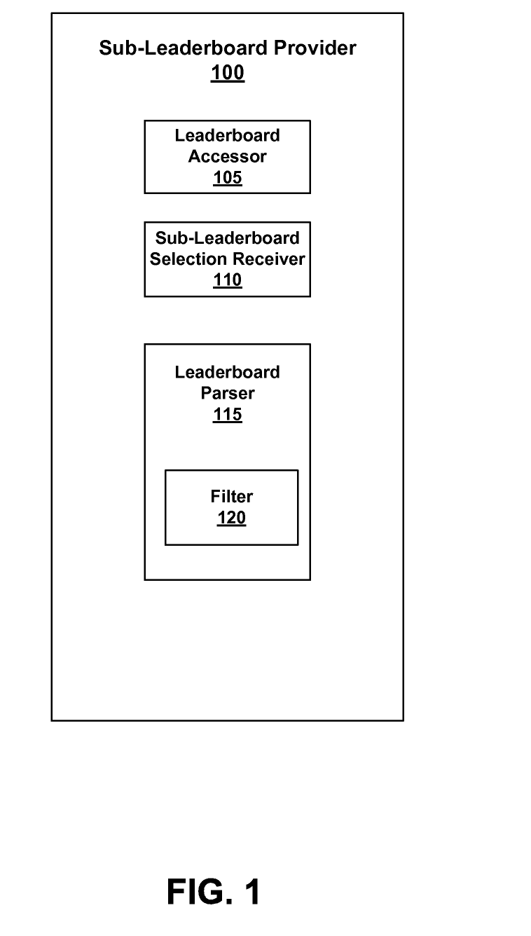

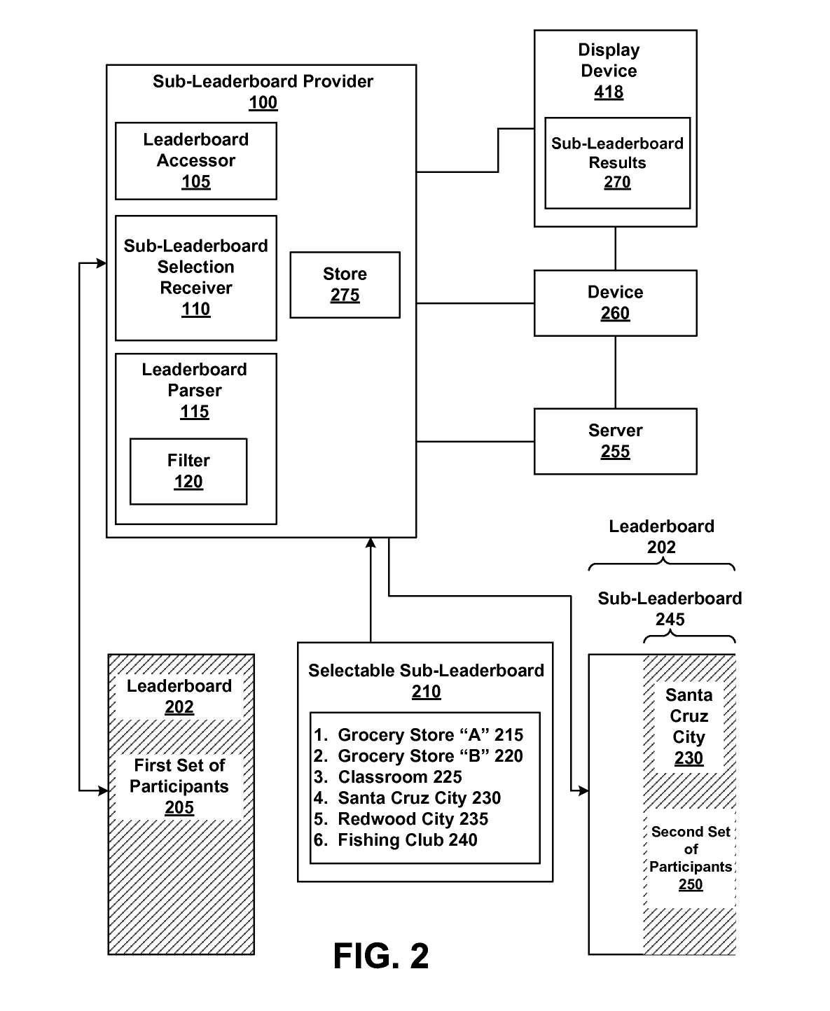

Unless specifically stated otherwise as apparent from the following discussions, it is appreciated that throughout the present Description of Embodiments, discussions utilizing terms such as “accessing,” “receiving”, “parsing”, “filtering” or the like, often refer to the actions and processes of an electronic computing device (or portion thereof), module or system, such as, but not limited to, a sub-leaderboard provider (See FIGS. 1 and 2). The electronic computing device/module/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview

A leaderboard is a means by which users can track their performance subjective to others. Leaderboards visually display where a user stands in regards to other users. A global leaderboard shows where the user is in relation to everyone on a website. Unless a user begins a leaderboard as a participant in a small group of known participants, the user remains unaware of how his performance compares to performance of participants whom the user personally knows. The user only knows how he has performed as compared with the public at large. Embodiments provide a device, system, and method for enabling a break-down of a leaderboard into one or more mini-leaderboards. Thus, even though a user initially begins participating in a global leaderboard, embodiments enable the user to modify an ongoing leaderboard to only display the user's performance in comparison with a selected category of people.

The following is a high-level non-limiting example. Emilie is participating in a gaming application. The gaming application is known to have about 40,000 regular participants. According to the leaderboard, which only records the top ten scoring leaders, Emilie has the ninth highest score out of all participants who have permitted their scores to be displayed. Emilie is also part of a gaming club at her high school. While having the ninth highest score is a good feat, Emilie is concerned that others in her gaming club are working hard to meet and beat her score. For example, Robert starting participating months after Emilie started, but he plays for four hours every day. Emilie would like to see Robert's score and progress on a daily basis.

Therefore, Emilie clicks on the selectable sub-leaderboard options on her display device to pull up her sub-leaderboard category selectable options. Emilie sees and clicks on the selectable option entitled, “Monte Vista Gaming Club”. After clicking on this option, the display device shows a sub-leaderboard of the Monte Vista Gaming Club. Every other participant of the leaderboard who was not a member of the Monte Vista Gaming Club was filtered out and does not appear in the list presented on the display device. While Emilie increased her scoring position to second, Emilie could see that Robert was closing on her fast, and was now in fourth place in the sub-leaderboard. What shocks Emilie though was that her friend Brenda is in the lead scoring position. Emilie had not even realized that Brenda was a member of the Monte Vista Gaming Club. Thus, embodiments provide a method for switching from an ongoing leaderboard that is global, to a localized sub-leaderboard, according to predefined (and stored) identifiable qualifying characteristics.

The following discussion will begin with a description of a sub-leaderboard provider, with reference to FIGS. 1 and 2. The discussion will follow with a description of a method of operation for providing a sub-leaderboard, with reference to FIGS. 1-3. The discussion concludes with a description of an example computer system with which or upon which various embodiments of the present technology may be implemented.

### Embodiments of a Sub-Leaderboard Provider

FIGS. 1 and 2 depict block diagrams that illustrates an embodiment of a sub-leaderboard provider 100 and a system 200 that includes the sub-leaderboard provider 100. The sub-leaderboard provider 100 includes, and as will be described below: a leaderboard accessor 105; a sub-leaderboard selection receiver 110; and a leaderboard parser 115. The leaderboard parser 115 includes a filter 120. Further, the sub-leaderboard provider 100 optionally includes a store 275 for holding selectable sub-leaderboard(s) 210.

The leaderboard accessor 105 is configured for accessing a leaderboard 202 that includes a first set of participants 205.

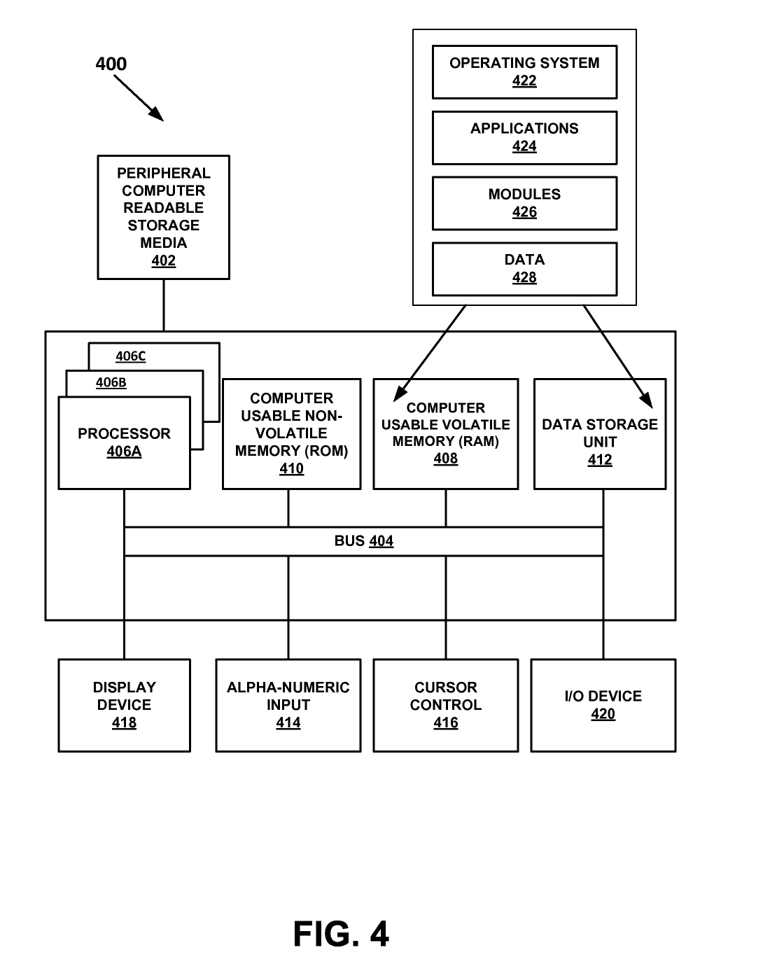

The sub-leaderboard selection receiver 110 is configured for receiving a selection of a selectable sub-leaderboard that includes a second set of participants. For example, FIG. 2 shows selectable sub-leaderboard(s) 210. In one embodiment, the selectable sub-leaderboard(s) 210 is displayed on a display device 418 (See FIG. 4). It should be appreciated that the selectable sub-leaderboard(s) 210 may include one or more selectable sub-leaderboards. Further, the number of participants in each of the selectable sub-leaderboards is less than the number of participants in the leaderboard 202. The selectable sub-leaderboards are selectable by a user via techniques known in the art for selecting a function displayed on a display device 418.

For example, but not limited to such example, a selectable sub-leaderboard 210 may be selected via clicking on an icon representing one of the selectable sub-leaderboard 210, input via a keyboard, audio input, etc. FIG. 2 shows six different selectable sub-leaderboard(s) 210: 1) grocery store “A” 215; 2) grocery store “B” 220; 3) classroom 225; 4) Santa Cruz City 230; 5) Redwood City 235; and 6) Fishing Club 240. In one embodiment, the store 275 stores the selectable sub-leaderboard(s) 210. The store 275, in one embodiment, is a data storage unit 412 as shown in FIG. 4. In optional embodiments, a server 255 and/or a device 260 with communication capabilities stores the selectable sub-leaderboard(s) 210 and communicates these selections via a display screen on the device 260 for a user to make a selection.

Thus, in one embodiment, the sub-leaderboard selection receiver 110 receives a selection of the fourth item, “Santa Cruz City” 230. The Santa Cruz City selection 230 includes a second set of participants 250. Upon selection, the user communicates the sub-leaderboard selection receiver 110 the selection, and the identifiable qualifying characteristics unique to the selection, as will be described below. In one embodiment, the second set of participants 250 is lesser in number than the first set of participants 205 of the leaderboard 202.

Each selectable sub-leaderboard 210 includes an identifiable qualifying characteristic unique unto itself. For example, each selectable sub-leaderboard 210 is predefined to be part of a particular category. For example, every participant of the grocery store “A” 215 category is predefined to be designated an employee of grocery store “A”. In various embodiments, this predefined information is stored at store 275, at device 260, and/or server 255. Thus, those participants in the leaderboard 202 who are not predefined to be an employee of grocery store “A” 215 are not part of the grocery store “A” 215 sub-leaderboard. These identifiable qualifying characteristics may be culled from general information available to the ordinary user, from answers to questions directed to the user and/or third parties and/or from third party and/or user-initiated requests and into to develop particular categories. In general, the identifiable qualifying characteristics may come from anywhere information is available.

The leaderboard parser 115 is configured for parsing the leaderboard 202 into at least one sub-leaderboard according to the selection made. The term, “parsing” refers to breaking the leaderboard data into smaller chunks of data by following a set of rules. For example, the leaderboard parser 115 breaks the data of the leaderboard 202 into smaller sub-leaderboards by following rules as set out in the predefined characteristics of each category of the selectable sub-leaderboard(s) 210. Each category, for example, grocery store “A” 215 has a set of participants that are predefined to include an identifiable qualifying characteristic that is unique to their category. For example, the identifiable qualifying characteristic of category one, grocery store “A” 215 is that all participants are employees of grocery store “A”. In another example, the identifiable qualifying characteristic of category six, fishing club 240 is that all participants are members of the fishing club, “Go Fish”. These identifiable qualifying characteristics are predefined and stored optionally at store 275, device 260 and/or server 255.

The filter 120 of the leaderboard parser 115 is configured for filtering out participants of the first set of participants that do not have the identifiable qualifying characteristic. Continuing with our example using the selected sub-leaderboard of grocery store “A” 215, any participant of the first set of participants 205 of the leaderboard 202 who is not predefined to be an employee of grocery store “A” will be filtered out of the leaderboard display such that the display only shows the second set of participants 250 who are employees of grocery store “A”.

In the example in which Santa Cruz City 230 was selected as the selectable sub-leaderboard 210, any participant of the first set of participants 205 of the leaderboard 202 who is not predefined to be a resident of Santa Cruz City will be filtered out of the leaderboard display such that the display only shows the second set of participants 250 who are residents of Santa Cruz City.

FIG. 2 shows a system 200 for providing a sub-leaderboard, in accordance with an embodiment. The system 200 includes; the sub-leaderboard provider 100; a display device 418; and optionally a device 260 and server 255. In one embodiment, the server 255 includes a data storage unit, such as the data storage unit 412 of FIG. 4. Additionally, in one embodiment, the server 255 uploads and/or updates the store 275 with new selectable sub-leaderboard(s) 210 and identifiable qualifying characteristic unique to each category represented by the selectable sub-leaderboard 210. In various embodiments, the device 260 with communication capabilities is configured to receive and/or access information, such as selectable sub-leaderboard(s) 210 and identifiable qualifying characteristics unique to the selectable sub-leaderboard(s) 210, as well as upload such information to the sub-leaderboard provider 100.

### Example Methods of Operation

The following discussion sets forth in detail some example methods of operation of embodiments. With reference to FIGS. 1-3, flow diagrams of method 300 illustrates an example procedure used by various embodiments. Method 300 includes some procedures that, in various embodiments, are carried out by a processor under the control of computer-readable and computer-executable instructions. In this fashion, procedures described herein and in conjunction with these flow diagrams, alone or in combination, are, or may be, implemented using a computer, in various embodiments.

The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware).

Although specific procedures are disclosed in method 300, such procedures are examples. That is, embodiments are well suited to performing various other procedures or variations of the procedures recited in method 300, alone or in combination. Likewise, in some embodiments, the procedures in method 300, alone or in combination, may be performed in an order different than presented and/or not all of the procedures described in one or more of these flow diagrams may be performed. It is further appreciated that procedures described in method 300, alone or in combination, may be implemented in hardware, or a combination of hardware with firmware and/or software.

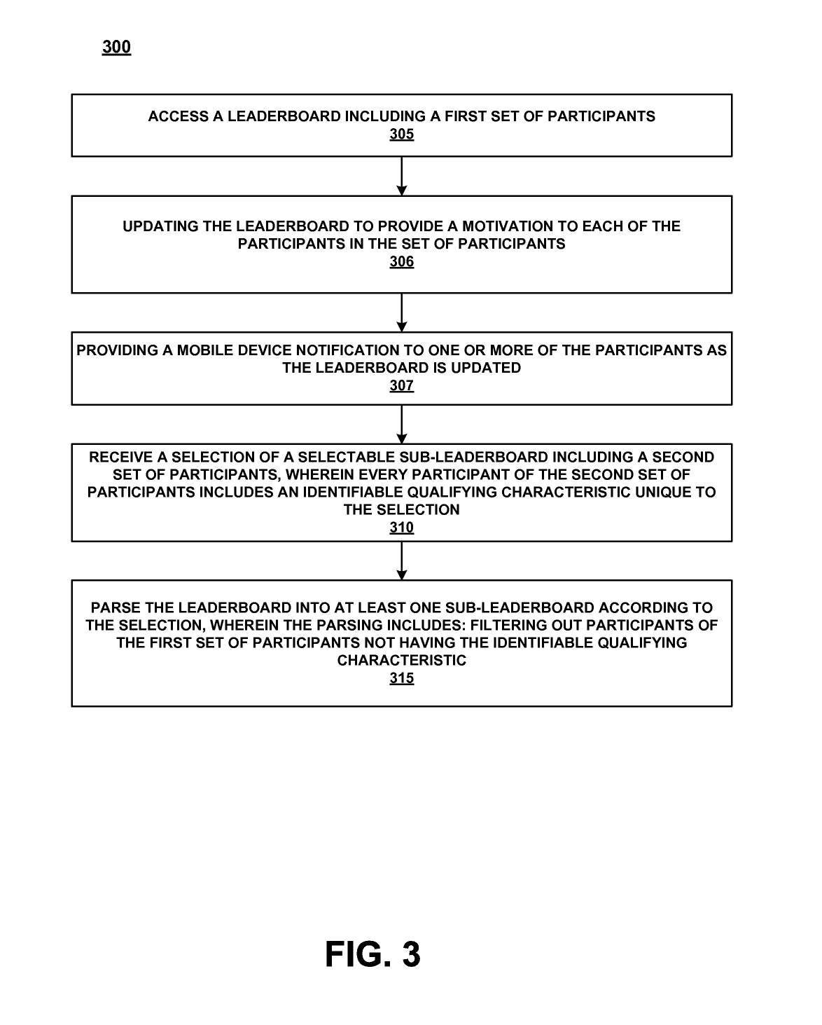

FIG. 3 is a flow diagram of a method 300 for providing a sub-leaderboard, in accordance with an embodiment. Although specific procedures are disclosed in method 300, embodiments are well suited to performing various other procedures or variations of the procedures recited in method 300. It is appreciated that the procedures in method 300 may be performed in an order different than presented, that not all of the procedures in method 300 may be performed, and that additional procedures to those illustrated and described may be performed. All of, or a portion of, the procedures described by method 300 can be implemented by a processor or computer system executing instructions which reside, for example, on computer-usable/readable media. The following discussion of method 300 references FIGS. 1, 2 and 3 unless specifically noted otherwise.

At 305 of method 300, in one embodiment and as described herein, the leaderboard 202 that includes a first set of participants 205 is accessed.

At 306 of method 300, one embodiment updates the leaderboard to provide a motivation to each of the participants in the set of participants.

At 307 of method 300, one embodiment provides a mobile device notification to one or more of the participants as the leaderboard is updated. In one embodiment, the participants may include an associate participant. In one embodiment, the participants may include a management entity.

At 310 of method 300, in one embodiment and as described herein, a selection of a selectable sub-leaderboard 210 is received, wherein the selectable sub-leaderboard selected includes a second set of participants 250. In one embodiment, every participant of the second set of participants 250 includes an identifiable qualifying characteristic unique to the selection made at 310 of method 300.

At 315 of method 300, in one embodiment and as described herein, the leaderboard 202 is parsed into at least one sub-leaderboard 245 according to the selection accessed at 310 of method 300. The parsing at 315 of method 300 includes filtering out the participants of the first set of participants 205 that do not have the identifiable qualifying characteristic.

### Gamification Based Performance Tracking

In one embodiment, the sub-leaderboard 245 can be used by a single retailer to provide gamification for sales associates competing within a store. That is, the sub-leaderboard and updates to the sub-leaderboard 245 provide a game-play style of motivation to each of the participants on the sub-leaderboard 245.

For example, the sub-leaderboard will include each employee of a certain store and will provide a competitive atmosphere with goals and rewards. In one embodiment, the associates would compete on a storewide goal, such as, which associate can sign up the most new customers to a rewards, loyalty or credit program. Once the challenge is issued, information related to the challenge would be provided to the sub-leaderboard in real time.

For example, each time an associate signs up a new customer and as the information is put into the register, that information is then used to update the sub-leaderboard 245 in the backroom. As such, the associates can check sub-leaderboard 245 to see their ranking, to see if they qualify for prizes or meet sales goals for rewards, bonuses or the like.

In one embodiment, the associates are provided with real-time updates or alerts such as emails, text messages or the like. The updates will let them know about changes on the sub-leaderboard 245 and an alert may be specifically related to a change in their personal sub-leaderboard 245 status.

For example, if Julie is leading the store in new customer credit signups, Julie and all other associates would be able to see the real-time scoring. As the end of the month nears, Julie could keep track of her lead. Similarly, Jimmy who is in second place could make a late push in customer sign-ups to try and overtake Julie's lead. As Jimmy closes the gap, both Jimmy and Julie could receive text updates to their mobile devices letting them know about the changing status of the competition. The text updates would provide motivation for Jimmy to sign up more customers in an attempt to overtake Julie. Similarly, the text updates would motivate Julie to continue to sign up customers and maintain her lead in the sub-leaderboard 245 standings.

Thus, by providing a game type scenario, e.g., gamification, the store will see an increase in whatever metric they have correlated with the sub-leaderboard 245 due to an increase in competitive spirit, rewards motivation, and the like that invigorates the associates. Similarly, the associates will be inspired by the real-time game style nature of the sub-leaderboard 245 to increase their productivity. Moreover, management will be able to monitor associates thereby resulting in better informed evaluations and real-time reports on associate's activities in the store.

### Example Computer System

With reference now to FIG. 4, all or portions of some embodiments described herein are composed of computer-readable and computer-executable instructions that reside, for example, in computer-usable/computer-readable storage media of a computer system. That is, FIG. 4 illustrates one example of a type of computer (computer system 400) that can be used in accordance with or to implement various embodiments which are discussed herein.

It is appreciated that computer system 400 of FIG. 4 is only an example and that embodiments as described herein can operate on or within a number of different computer systems including, but not limited to, general purpose networked computer systems, embedded computer systems, routers, switches, server devices, client devices, various intermediate devices/nodes, stand-alone computer systems, distributed computer systems, media centers, handheld computer systems, multi-media devices, and the like. Computer system 400 of FIG. 4 is well adapted to having peripheral non-transitory computer-readable storage media 402 such as, for example, a floppy disk, a compact disc, digital versatile disc, other disc based storage, universal serial bus “thumb” drive, removable memory card, and the like coupled thereto.

System 400 of FIG. 4 includes an address/data bus 404 for communicating information, and a processor 406A coupled with bus 404 for processing information and instructions. As depicted in FIG. 4, system 400 is also well suited to a multi-processor environment in which a plurality of processors 406A, 406B, and 406C are present.

Conversely, system 400 is also well suited to having a single processor such as, for example, processor 406A. Processors 406A, 406B, and 406C may be any of various types of microprocessors. System 400 also includes data storage features such as a computer usable volatile memory 408, e.g., random access memory (RAM), coupled with bus 704 for storing information and instructions for processors 406A, 406B, and 406C.

System 400 also includes computer usable non-volatile memory 410, e.g., read only memory (ROM), coupled with bus 404 for storing static information and instructions for processors 406A, 406B, and 406C. Also present in system 400 is a data storage unit 412 (e.g., a magnetic or optical disk and disk drive) coupled with bus 404 for storing information and instructions. System 400 also includes an optional alphanumeric input device 414 including alphanumeric and function keys coupled with bus 404 for communicating information and command selections to processor 406A or processors 406A, 406B, and 406C.

System 400 also includes an optional cursor control device 416 coupled with bus 404 for communicating user input information and command selections to processor 406A or processors 406A, 406B, and 406C. In one embodiment, system 400 also includes an optional display device 418 coupled with bus 404 for displaying information.

Referring still to FIG. 4, optional display device 418 of FIG. 4 may be a liquid crystal device, cathode ray tube, plasma display device or other display device suitable for creating graphic images and alphanumeric characters recognizable to a user. Optional cursor control device 416 allows the computer user to dynamically signal the movement of a visible symbol (cursor) on a display screen of display device 418 and indicate user selections of selectable items displayed on display device 418. Many implementations of cursor control device 416 are known in the art including a trackball, mouse, touch pad, joystick or special keys on alphanumeric input device 414 capable of signaling movement of a given direction or manner of displacement.

Alternatively, it will be appreciated that a cursor can be directed and/or activated via input from alphanumeric input device 414 using special keys and key sequence commands. System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet.

Referring still to FIG. 4, various other components are depicted for system 400. Specifically, when present, an operating system 422, applications 424, modules 426, and data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, computer-readable storage media within data storage unit 412, peripheral computer-readable storage media 402, and/or other tangible computer-readable storage media.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A non-transitory computer-readable storage medium having instructions embodied therein that when executed causes a computing device to perform a computer-implemented method for gamification based performance tracking, said computer-implemented method comprising:
accessing a leaderboard comprising a set of participants;
updating the leaderboard to provide a motivation to each of the participants in the set of participants; and
providing a mobile device notification to one or more of the participants as the leaderboard is updated.

2. The computer-implemented method of claim 1 further comprising:
receiving a selection of a selectable sub-leaderboard comprising a second set of participants, wherein every participant of said second set of participants comprises an identifiable qualifying characteristic unique to said selection; and
parsing said leaderboard into at least one sub-leaderboard according to said selection, wherein said parsing comprising:
filtering out participants of said set of participants not having said identifiable qualifying characteristic.

3. The computer-implemented method of claim 2 further comprising:
utilizing a participant's employment at a single retail store as said identifiable qualifying characteristic unique to said selection.

4. The computer-implemented method of claim 2 further comprising:
utilizing a participant's membership in a club as said identifiable qualifying characteristic unique to said selection.

5. The computer-implemented method of claim 2 further comprising:
obtaining said identifiable qualifying characteristic unique to said selection from the group consisting of: an answer to a question directed to a participant, an answer to a question about a participant directed to a third party, information provided by a third party, and a participant initiated requests.

6. The computer-implemented method of claim 1 further comprising:
updating the leaderboard in real-time to provide a game-play type of motivation to each of the participants in the set of participants; and
providing said mobile device notifications to one or more of the participants in real-time as the leaderboard is updated.

7. The computer-implemented method of claim 1 wherein the one or more of the participants is selected from the group consisting of: an associate participant and a management entity.

8. The computer-implemented method of claim 1 further comprising:
texting the mobile device notification to at least one associate participant as the leaderboard is updated.

9. The computer-implemented method of claim 1 further comprising:
emailing the mobile device notification to at least one associate participant as the leaderboard is updated.

10. The computer-implemented method of claim 1 further comprising:
texting the mobile device notification to at least one management entity as the leaderboard is updated.

11. The computer-implemented method of claim 1 further comprising:
emailing the mobile device notification to at least one management entity as the leaderboard is updated.

12. A non-transitory computer-readable storage medium having instructions embodied therein that when executed causes a computing device to perform a computer-implemented method for gamification based performance tracking, said computer-implemented method comprising:
accessing a leaderboard comprising a first set of participants;
receiving a selection of a selectable sub-leaderboard comprising a second set of participants, wherein every participant of said second set of participants comprises an identifiable qualifying characteristic unique to said selection;
parsing said leaderboard into at least one sub-leaderboard according to said selection, wherein said parsing comprising:
filtering out participants of said first set of participants not having said identifiable qualifying characteristic;
updating the sub-leaderboard in real-time; and
providing a mobile device notification to one or more of the participants in the second set of participants in real-time as the sub-leaderboard is updated.

13. The computer-implemented method of claim 12 further comprising:
utilizing a participant's employment at a single retail store as said identifiable qualifying characteristic unique to said selection.

14. The computer-implemented method of claim 12 further comprising:
utilizing a participant's membership in a club as said identifiable qualifying characteristic unique to said selection.

15. The computer-implemented method of claim 12 further comprising:
obtaining said identifiable qualifying characteristic unique to said selection from the group consisting of: an answer to a question directed to a participant, an answer to a question about a participant directed to a third party, information provided by a third party, and a participant initiated requests.

16. The computer-implemented method of claim 12 further comprising:
utilizing said sub-leaderboard to promote a storewide challenge.

17. The computer-implemented method of claim 16 further comprising:
selecting the storewide challenge from a list of challenges consisting of: a signing up of customers to a rewards program, a signing up of customers to a loyalty program, and a signing up of customers to a credit program.

18. The computer-implemented method of claim 12 further comprising:
selecting the mobile device notification from the group consisting of: an email update, a text update, an email alert, and a text alert.

19. A gamification based performance tracking system comprising:
a leaderboard accessor, said leaderboard accessor configured to access a leaderboard comprising a first set of participants;
a sub-leaderboard selection receiver, said sub-leaderboard selection receiver configured to receive a selection of a selectable sub-leaderboard comprising a second set of participants, wherein every participant of said second set of participants comprises an identifiable qualifying characteristic unique to said selection;
a leaderboard parser, said leaderboard parser configured to parse said leaderboard into at least one sub-leaderboard of said second set of participants according to said selection;
a sub-leaderboard provider, said sub-leaderboard provider configured to update the sub-leaderboard in real-time; and
a communication device, said communication device configured to provide a mobile device notification to one or more of the participants in the second set of participants in real-time as the sub-leaderboard is updated.

20. The gamification based performance tracking system of claim 19 wherein said leaderboard parser comprises:
a filter, said filter configured to filter out participants of said first set of participants not having said identifiable qualifying characteristic to generate said sub-leaderboard.
